(19) United States
(12) Patent Application Publication
(10) Pub. No.: US 2005/0243486 A1
(43) Pub. Date: Nov. 3, 2005

(54) Frequency selective grounding method and arrangement

(75) Inventors: William J. Wingfield, Plantation, FL (US); Wilfred L. Armstrong, Pompano Beach, FL (US); Minh C. Nguyen, Miramar, FL (US)

Correspondence Address: AKERMAN SENTERFITT, P.O. BOX 3188, WEST PALM BEACH, FL, 33402-3188, US

(73) Assignee: Motorola, Inc., Schaumburg, IL (US)

(21) Appl. No.: 10/837,417

(22) Filed: Apr. 30, 2004

(51) Int. Cl. H02H 9/06

(52) U.S. Cl. 361/56

(57) ABSTRACT

A grounding arrangement (19) for a communication product (10) can include an external conductive surface (12), an internal ground (50), and a frequency selective ground path between the external conductive surface and the internal ground. The frequency selective ground path (54 and/or 56) provides for a high impedance path between the external conductive surface and the internal ground for signals at a predetermined operating frequency range for the communication product and a low inductance path between the external conductive surface and the ground for signals operating at electrostatic frequencies. The internal ground can reside on the surface of a printed circuit board (18) within the communication product and the external conductive surface can be coupled to the internal ground via a spring contact (20) and an inductor (54) or a resonant circuit (54 and 56).

### CROSS-REFERENCE TO RELATED APPLICATIONS

Not applicable

### FIELD OF THE INVENTION

This invention relates generally to grounding techniques and arrangements, and more particularly to a method and arrangement for grounding a communication device.

### BACKGROUND OF THE INVENTION

Cellular phones and other hand-held electronic devices are typically exposed to Electrostatic Discharge (ESD) in the course of operation and must provide a pre-defined immunity to this environmental electrical stress. It is often desirable to ground any metallic external components of the hand-held device to provide a controlled discharge path for the ESD. It is also often necessary to isolate some of the external metallic components to enhance Antenna System performance.

Metallic keypad bezels and surface coverings are widely used throughout the telecommunication industries and other consumer product industries. Common applications have the external metallic surfaces screwed to the radio chassis providing a common ground. Although such existing arrangement provides adequate grounding, no compensation is provided in such existing grounding arrangements to reduce adverse effects to antenna system performance.

### SUMMARY OF THE INVENTION

Embodiments in accordance with the present invention utilize frequency selective circuits to provide appropriate ESD grounding while also allowing for optimal antenna performance. In a first embodiment of the present invention, a method of grounding for a communication product operating in a predetermined frequency range can include the steps of providing a high impedance path between an external conductive surface of the communication product and a ground for signals operating at the predetermined frequency range and providing a low impedance path between the external conductive surface of the communication product and the ground for signals operating at electrostatic frequencies. The external conductive surface can be a metallic keypad bezel, a metallic housing, or a metallic battery cover for example. Ground can be a metallic surface on an internal chassis of the communication product such as a ground plane on a printed circuit board. Furthermore, the high impedance path to ground and the low impedance path to ground can be created from the external conductive surface through a spring contact and an inductor to ground.

In a second embodiment of the present invention, another method of grounding for a communication product operating in a predetermined frequency range can include the step of frequency selective grounding of an external conductive surface of the communication product to a ground. The frequency selective grounding creates a high impedance path between the external conductive surface and the ground for signals operating at the predetermined frequency range and a low impedance path between the external conductive surface of the communication product and the ground for signals operating at electrostatic frequencies.

In a third embodiment of the present invention, a grounding arrangement for a communication product can include an external conductive surface, an internal ground, and a frequency selective ground path between the external conductive surface and the internal ground. The frequency selective ground path provides for a high impedance path between the external conductive surface and the internal ground for signals at a predetermined operating frequency range for the communication product and a low impedance path between the external conductive surface of the communication product and the ground for signals operating at electrostatic frequencies. The internal ground can reside on the surface of a printed circuit board within the communication product and the external conductive surface can be coupled to the internal ground via a spring contact and an inductor or a resonant circuit or network. Optionally, the external conductive surface can be coupled to the internal ground on the printed circuit board via a ferrite bead in series with the internal ground.

In a fourth embodiment of the present invention, a communication product having a grounding arrangement can include an external housing, an external conductive surface on the external housing, an internal ground, and a frequency selective ground path between the external conductive surface and the internal ground. The frequency selective ground path provides a high impedance path between the external conductive surface and the internal ground for signals at a predetermined operating frequency range and a low impedance path between the external conductive surface of the communication product and the ground for signals operating at electrostatic frequencies. Note, the communication product can be a cellular phone, a two-way radio, a smart phone, a combination cellular phone and personal digital assistant, a home cordless phone, a satellite phone, a two-way pager, a transmitter beacon or generally any communication device having a transmitter. The communication product can further include a keypad placed between the printed circuit board and the external housing as well as an antenna and a transmitter. The external conductive surface can be coupled to the internal ground on the printed circuit board via a ferrite bead in series with the internal ground.

In a fifth embodiment of the present invention, a communication product having a grounding arrangement can include an external housing having a plurality of apertures, a metallic keypad bezel on the external housing having a plurality of apertures, a printed circuit board having a grounding contact and circuitry coupled to a transmitter and an antenna, and a keypad placed between the printed circuit board and the external housing, wherein a plurality of keys protrude through the plurality of apertures in the external housing and the metallic keypad bezel. Furthermore, the communication product can include a frequency selective ground path between the external metallic surface and the internal ground. The frequency selective ground path provides a high impedance path between the external conductive surface and the internal ground for signals at a predetermined operating frequency range for the communication product and a low impedance path between the external conductive surface of the communication product and the ground for signals operating at electrostatic frequencies.

### BRIEF DESCRIPTION OF THE DRAWINGS

FIG. 1 is a block diagram of a communication product having a grounding arrangement in accordance with an embodiment of the present invention.

FIG. 2 is an exploded view of a communication product having a grounding arrangement in accordance with an embodiment of the present invention.

FIG. 3 illustrates a schematic diagram of circuitry used on a printed circuit board in accordance with an embodiment of the present invention.

FIG. 4 is a flow chart illustrating a method of grounding in accordance with an embodiment of the present invention.

### DETAILED DESCRIPTION OF THE DRAWINGS

While the specification concludes with claims defining the features of embodiments of the invention that are regarded as novel, it is believed that the invention will be better understood from a consideration of the following description in conjunction with the figures, in which like reference numerals are carried forward.

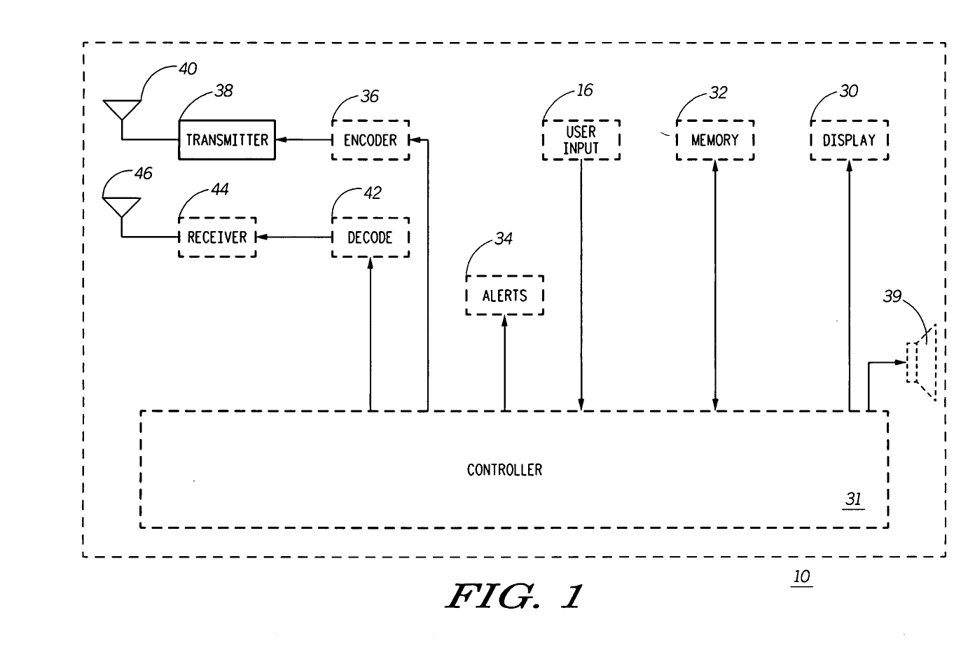

In one embodiment in the form of a cellular phone 10 as shown in FIGS. 1-3, a grounding arrangement or frequency selective grounding circuit 19 in accordance with the invention can allow for the grounding of an external conductive surface such as metallic keypad bezel 12 to a radio system main ground 50 on a substrate or printed circuit board (PCB) 18 by using the frequency selective grounding circuit 19 to provide a low resistance DC path to ground and a low-impedance to ground for ESD impulses discharged to the metallic keypad bezel 12, but also provides a high impedance path to ground at radio frequencies at which a transmitter (38) or transceiver (38 and 44) operates. The high impedance path prevents or significantly reduces degraded performance of the antenna system (40 and 46). In other words, a frequency selective circuit can provide the appropriate ESD grounding while also allowing for optimal antenna performance.

Referring to FIG. 1, a block diagram of a communication product such as the cellular phone 10 can comprise a conventional cellular phone, a two-way trunked radio, a combination cellular phone and personal digital assistant, a smart phone, a home cordless phone, a satellite phone or any other communication device having a transmitter and a grounding arrangement in accordance with the embodiments of the present invention. In this particular embodiment, the cellular phone 10 can include an encoder 36, transmitter 38 and antenna 40 for encoding and transmitting information as well as an antenna 46, receiver 44 and decoder 42 for receiving and decoding information sent to the cellular phone 10. The phone 10 can further include an alert 34, a memory 32, a user input device 16 (such as a keyboard, mouse, voice recognition program, etc.), a speaker or annunciator 39, and a display 30 for displaying a graphical user interface (GUI) or other information. The device 10 can further include a processor or controller 31 coupled to the display 30, the encoder 36, the decoder 42, the alert 34, the user input 16 and the memory 32.

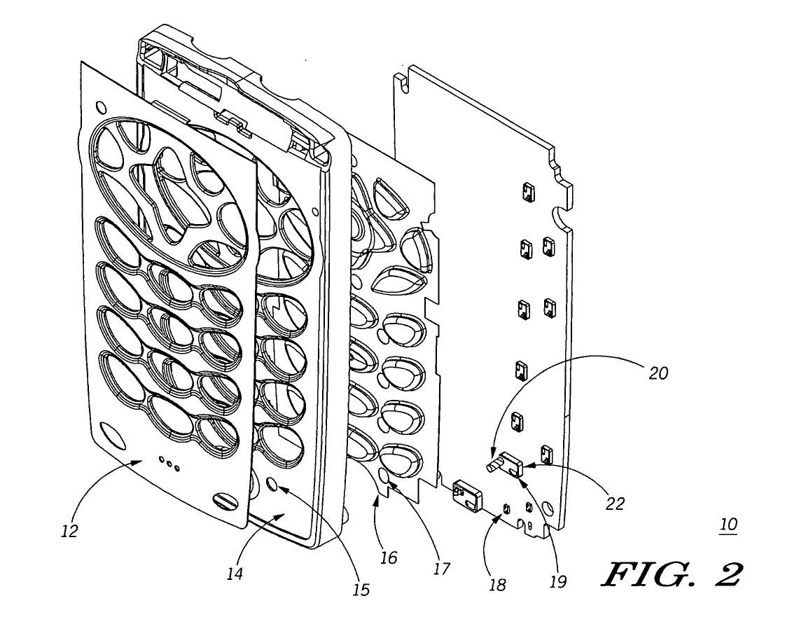

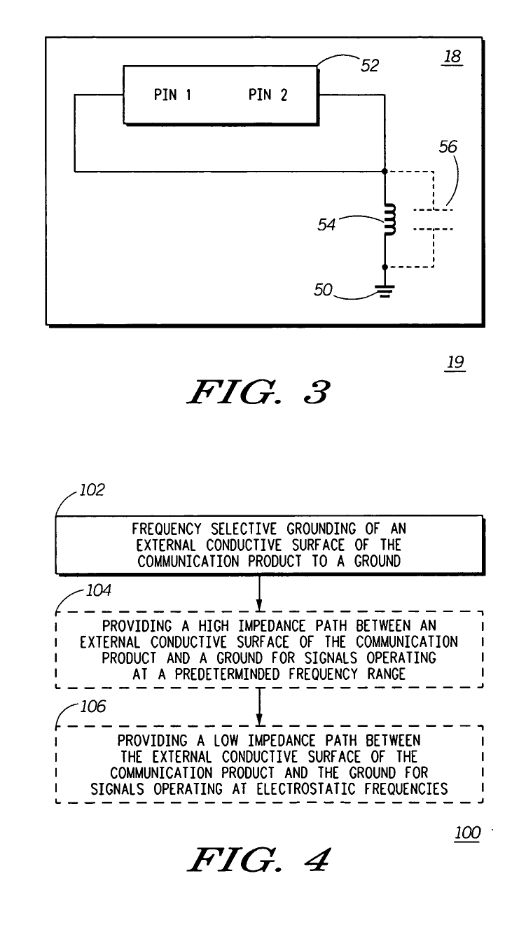

Referring to FIG. 2, an exploded view of the cellular phone 10 is shown. Mechanically, an embodiment of the present invention can include an external conductive surface such as the metallic keypad bezel 12 that couples to a ground 50 as shown in FIG. 3 via a grounding arrangement or frequency selective circuit 19 that can be formed on a substrate such as the PCB 18. Note that the external conductive surface can be an external housing 14 or a portion of such housing that encases the cellular phone 10 and is not limited to the bezel 12. In this instance though, the external housing is non-conductive and carries the metallic keypad bezel 12. Both the external housing 14 and the bezel 12 have a plurality of corresponding apertures for allowing a plurality of keys from a keypad 16 to protrude through such corresponding apertures. The keypad 16 can be non-conductive and can be placed between the PCB 18 and the bezel 12 and/or external housing 14. Furthermore, the communication product can include a frequency selective ground path between the external metallic surface (12) and the internal ground 50. Contact between metallic keypad bezel 12 and the ground (50) on the PCB 18 can be achieved through a spring contact 20 and an inductor 54 (as shown in FIG. 3) although many other alternative arrangements can be made that provide the same functionality. Optionally, a ferrite bead 22 can be used in the frequency selective circuit 19 to suppress unwanted signals. Ferrite beads can provide attenuation of selected frequency bands. The physical shape of ferrite beads is similar to a toroidal inductor, but the beads have a greater length to diameter ratio and usually a greater outside to inside diameter ratio than most toroid cores. Different size/shape beads of the same material have different degrees of suppression. The type of ferrite material used to manufacture the bead determines the range of frequencies for suppression purposes, and the physical size and shape of the bead determines the amount of attenuation. In general the impedance is directly proportional to the length of the ferrite beads.

The frequency selective ground path provides a high impedance path between the metallic keypad bezel 12 and the internal ground 50 for signals at a predetermined operating frequency range for the communication product and a low impedance path between the metallic keypad bezel 12 and the internal ground 50 for signals operating at electrostatic frequencies. The operating frequency for the cellular phone or other communication product can typically range from 450 MHz to over 2.4 GHz whereas the ESD frequencies typically range from the low 100 kHz to low MHz range. Referring once again to FIG. 3, the grounding arrangement or frequency selective circuit 19 can include a grounding inductor 54 and optionally a capacitor 56 that can form a parallel resonant circuit (with high-impedance) at the operating frequency of the cellular phone 10 and a low impedance (and low inductance) path at ESD frequencies. The grounding arrangement 19 can include a solder pad or contact area 52 that enables a spring 20 (as shown in FIG. 2) to physically contact the underside of the metallic keypad bezel 12 (via apertures 17 and 15 in the keypad 16 and housing 14 respectively). The contact area 52 also connects to the grounding inductor 54 or resonant circuit. Again, this arrangement provides a low impedance to ground for ESD frequencies, but a radio frequency (RF) “Open” for radiated transmitter energy.

In summary, the embodiment shown in FIGS. 1-3 includes a metallic keypad bezel 12, an external housing 14, a PCB 18 having a metallic contact such as a spring 20 soldered to a contact area 52 on the PCB 18 that further contacts frequency selective electrical components on the PCB 18. The keypad bezel 12 is part of the front assembly of the cellular phone 10 and is contacted by the metallic contact (in the form of a metallic spring 20) soldered onto the PCB 18. The spring 20 can be connected to the ground (50) of the PCB through a frequency selective circuit (54 and/or 56).

In the typical grounding of a metallic bezel, a spring contact is used to simultaneously contact the metallic bezel and the ground of the PCB. This existing arrangement for a ground path is a low impedance path at both low (ESD) and high (RF) frequencies. Providing a low-impedance path to ground at the RF frequencies of a transceiver or transmitter detunes antenna performance and can adversely affect antenna gain. Using frequency selective grounding herein can provide a low-impedance to ground at lower frequencies typical of ESD but a high impedance to ground at RF frequencies.

Referring to FIG. 4, a flow chart illustrating a method 100 of grounding for a communication product operating in a predetermined frequency range. The method 100 can include the step 102 of frequency selective grounding an external conductive surface of the communication product to a ground. More specifically, the method 100 can provide a high impedance path between an external conductive surface of the communication product and a ground for signals operating at the predetermined frequency range at step 104 and can also provide a low impedance path between the external conductive surface of the communication product and the ground for signals operating at electrostatic frequencies at step 106.

In light of the foregoing description, it should be recognized that embodiments in accordance with the present invention can be realized in numerous configurations contemplated to be within the scope and spirit of the claims. Additionally, the description above is intended by way of example only and is not intended to limit the present invention in any way, except as set forth in the following claims.

1. A method of grounding for a communication product operating in a predetermined frequency range, comprising the steps of:
providing a high impedance path between an external conductive surface of the communication product and a ground for signals operating at the predetermined frequency range; and
providing a low impedance path between the external conductive surface of the communication product and the ground for signals operating at electrostatic frequencies.

2. The method of claim 1, wherein the external conductive surface is selected among a metallic keypad bezel, a metallic housing, or a metallic battery cover.

3. The method of claim 1, wherein the high impedance path to the ground and the low impedance path to the ground are created from the external conductive surface through a spring contact and an inductor to the ground.

4. The method of claim 1, wherein the ground is a metallic surface on an internal chassis of the communication product.

5. A method of grounding for a communication product operating in a predetermined frequency range, comprising the steps of:
frequency selective grounding of an external conductive surface of the communication product to a ground wherein a high impedance path between the external conductive surface and the ground exists for signals operating at the predetermined frequency range and a low inductance path exists between the external conductive surface of the communication product and the ground for signals operating at electrostatic frequencies.

6. A grounding arrangement for a communication product, comprising:
an external conductive surface;
an internal ground; and
a frequency selective ground path between the external conductive surface and the internal ground, wherein a high impedance path between the external conductive surface and the internal ground exists for signals at a predetermined operating frequency range for the communication product and a low impedance path exists between the external conductive surface of the communication product and the ground for signals operating at electrostatic frequencies.

7. The grounding arrangement of claim 6, wherein the external conductive surface is at least one among a metallic keypad bezel, a housing, or a battery cover for the communication product.

8. The grounding arrangement of claim 6, wherein the communication product is selected from the group comprising a cellular phone, a two-way radio, a smart phone, a combination cellular phone and personal digital assistant, a home cordless phone, a satellite phone, a two-way pager, or a transmitter beacon.

9. The grounding arrangement of claim of 6, wherein the internal ground resides on the surface of a printed circuit board.

10. The grounding arrangement of claim 6, wherein the external conductive surface is coupled to the internal ground via a spring contact and an inductor.

11. The grounding arrangement of claim 9, wherein the external conductive surface is coupled to the internal ground on the printed circuit board via a ferrite bead in series with the internal ground.

12. A communication product having a grounding arrangement, comprising:
an external housing;
an external conductive surface on the external housing;
an internal ground; and
a frequency selective ground path between the external conductive surface and the internal ground, wherein a high impedance path between the external conductive surface and the internal ground exists for signals at a predetermined operating frequency range for the communication product and a low impedance path exists between the external conductive surface of the communication product and the ground for signals operating at electrostatic frequencies.

13. The communication product of claim 12, wherein the external conductive surface is a metallic keypad bezel for the communication product.

14. The communication product of claim 12, wherein the communication product is selected from the group comprising a cellular phone, a two-way radio, a smart phone, a combination cellular phone and personal digital assistant, a home cordless phone, a satellite phone, a two-way pager, or a transmitter beacon.

15. The communication product of claim of 12, wherein the internal ground resides on the surface of a printed circuit board within the external housing.

16. The communication product of claim 12, wherein the external conductive surface is coupled to the internal ground via a spring contact and an inductor.

17. The communication product of claim 15, wherein the external conductive surface is coupled to the internal ground on the printed circuit board via a ferrite bead in series with the internal ground.

18. The communication product of claim 15, wherein the communication product further comprises a keypad placed between the printed circuit board and the external housing.

19. The communication product of claim 12, wherein the communication product further comprises an antenna and a transmitter.

20. A communication product having a grounding arrangement, comprising:
an external housing having a plurality of apertures;
a metallic keypad bezel on the external housing having a plurality of apertures;
a printed circuit board having a grounding contact and circuitry coupled to a transmitter and an antenna;
a keypad placed between the printed circuit board and the external housing, wherein a plurality of keys protrude through the plurality of apertures in the external housing and the metallic keypad bezel; and
a frequency selective ground path between the external metallic surface and the internal ground, wherein a high impedance path between the external conductive surface and the internal ground exists for signals at a predetermined operating frequency range for the communication product and a low impedance path exists between the external conductive surface of the communication product and the ground for signals operating at electrostatic frequencies.
